(19) United States
(12) Patent Application Publication
(10) Pub. No.: US 2017/0228744 A1
(43) Pub. Date: Aug. 10, 2017

(54) E-COMMERCE SYSTEM WITH DEMAND FORECASTING TOOL

(71) Applicant: BuildDirect.com Technologies Inc., Vancouver (CA)

(72) Inventors: Jeff Booth, Richmond (CA); Hilen Amin, London (GB); Tal Ball, Vancouver (CA); Raam Baranidharan, Bengaluru (IN); Dan Brodie, Richmond (CA)

(21) Appl. No.: 15/428,027

(22) Filed: Feb. 8, 2017

Related U.S. Application Data
(60) Provisional application No. 62/293,275, filed on Feb. 9, 2016.

(51) Int. Cl. G06Q 30/02; G06Q 30/06

(52) U.S. Cl. CPC G06Q 30/0202; G06Q 30/0633; G06Q 30/0639; G06Q 30/0201; G06F 3/0482

(57) ABSTRACT

An e-commerce server system including a demand forecasting tool configured to compute a base demand forecast based on actual shopping cart conversions determined from the historical cart data; compute an optimized-stock demand forecast by examining the historical cart data and determining a set of shopping carts in which the target product was not purchased and was out of stock, or was purchased but out of stock at the highest conversion rate product location, and for each shopping cart identify a highest potential conversion rate among the seller's active product locations, and augment the base demand forecast by the highest potential conversion rate for the shopping carts; and compute an opportunity demand forecast by, for each shopping cart, identifying a highest potential conversion rate among the seller's active and inactive product locations, and augmenting the base demand forecast by the highest potential conversion rate for each of the shopping carts.

### BACKGROUND

The inventors herein have recognized that in an e-commerce system in which sellers warehouse their goods in various different warehouses at geographically disparate locations, and offer those goods to potential buyers via the e-commerce system, buyers who show initial interest in a product may ultimately choose not to purchase it from a particular seller due to high shipping costs and shipping delay. Such lost opportunities result in lost revenue for the seller, and for the e-commerce system as a whole, and may frustrate the buyer.

### SUMMARY

To address the above issue, an e-commerce system is disclosed. The e-commerce system may include a seller interface server program executed on a server of the e-commerce server system configured to display a seller interface by which a seller may upload product data on one or more products to be offered for sale, and by which the seller may designate a plurality of product locations that can store and ship products, the plurality of product locations being active product locations or inactive product locations depending on a designation by the seller, wherein the product data includes a product identification, a product price, and a product location for each product, and wherein the product location for each product is selectable from the active product locations.

The e-commerce system may further include an e-commerce marketplace server program executed on the server and configured to display a customer interface that displays products viewed by a customer, and provides a virtual shopping cart configured to have products added to it by the customer, the virtual shopping cart including an associated purchasing tool for purchasing products in the virtual shopping cart. The e-commerce system may further include a data collection module executed on the server computer configured to collect historical cart data indicating customer views of products, products added to virtual shopping carts, and products purchased via the purchasing tool. The e-commerce system may further include a logistic regression conversion module configured to compute a conversion rate for the target product based on the historical shopping cart data.

The seller interface server program may include a demand forecasting tool configured to: (1) compute a base demand forecast for a predetermined time period based on actual shopping cart conversions over a corresponding past period of time determined from the historical cart data; (2) compute an optimized-stock demand forecast by examining the historical cart data and determining a set of the virtual shopping carts within the past corresponding period time in which the target product was not purchased and was out of stock, or in which the target product was out of stock in a product location with a highest conversion rate and was purchased from a product location with a lower than highest conversion rate, and for each of the virtual shopping carts in the set identify a highest potential conversion rate among the active product locations, and augment the base demand forecast by the highest potential conversion rate for each of the virtual shopping carts; (3) compute an opportunity demand forecast by, for each of the virtual shopping carts in the set, identifying a highest potential conversion rate among the active product locations and the inactive product locations, and augmenting the base demand forecast by the highest potential conversion rate for each of the virtual shopping carts in the set; and (4) display or cause to be displayed at least a result of the optimized-stock demand forecast, and the opportunity demand forecast.

The demand forecasting tool may further be configured to enable the seller to modify the active product locations to simulate a modified set of active product locations, and re-compute the optimized-stock demand forecast based on the modified set of active product locations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an embodiment of an e-commerce system according to the present disclosure.

FIG. 2 is a performance dashboard screen displayed by a performance metrics tool of the system of FIG. 1.

FIGS. 3A-3C are screens displayed by the demand forecasting tool in which a seller interacts with an opportunity demand forecast.

FIGS. 4A and 4B are SKU-level screens displayed by the demand forecasting tool in which a seller interacts with an opportunity demand forecast, on a per-SKU and per-product location basis.

FIG. 5 is a schematic view showing the flow of products from a seller to a customer via one of three product locations determined by a product distribution plan of the seller, according to the management of the e-commerce server system.

FIG. 6 is a flowchart for a method of e-commerce demand forecasting.

FIG. 7 is a simplified schematic view of an example computing system that may be used as one or more of the computing devices of the e-commerce system of FIG. 1.

### DETAILED DESCRIPTION

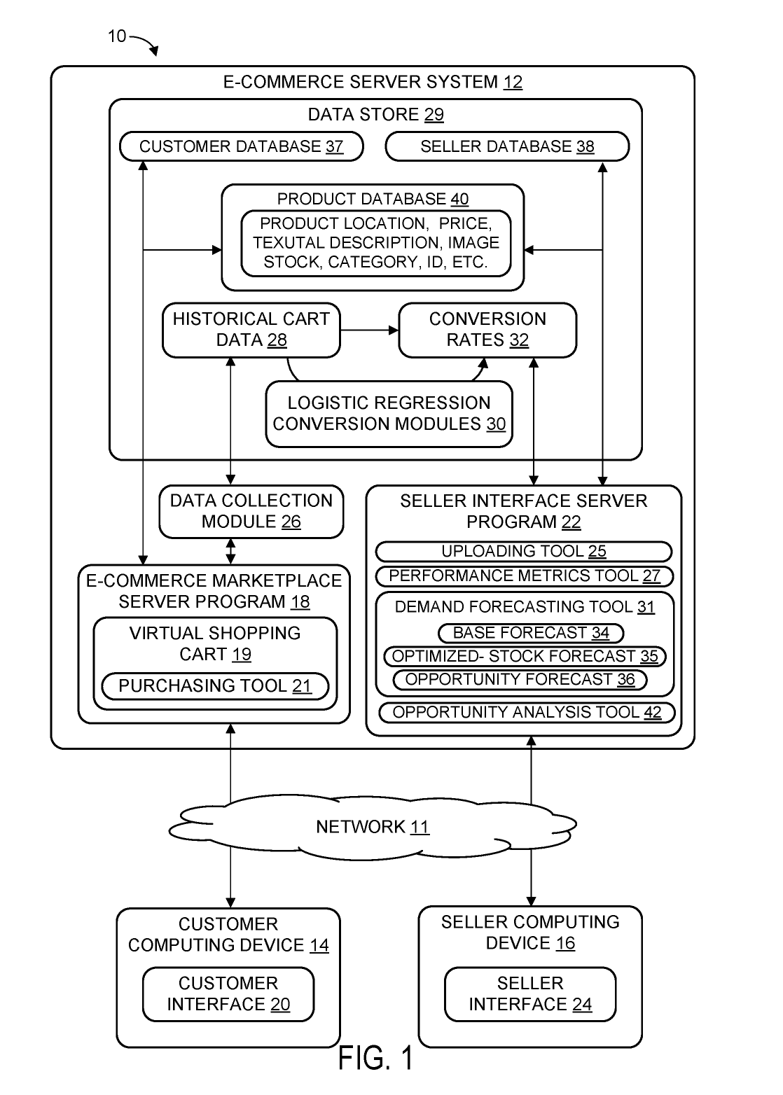

Referring to FIG. 1, an e-commerce system 10 in accordance with one embodiment of this disclosure is schematically shown in simplified form. The e-commerce system 10 includes an e-commerce server system 12 configured to communicate via a network 11 with a customer 13 through a customer computing device 14 and with a seller 15 through a seller computing device 16.

The e-commerce server system 12 includes a seller interface server program 22 executed on a server of the e-commerce server system 12. The seller interface server program 22 is configured to display a seller interface 24 on a seller computing device 16 by which a seller 15 may upload product data 17a on one or more products 17 to be offered for sale. The product data 17a may be input into a seller computing device 16 by the seller 15 via an uploading tool 25, and seller data 15a about the seller 15 itself may also be input via the uploading tool 25. The seller interface 24 may also allow the seller 15 to designate a plurality of product locations 23 that can store and ship products, the plurality of product locations 23 being active product locations 23a or inactive product locations 23b depending on a designation by the seller 15. The product data includes a product identification, a product price, and a product location for each product, and wherein the product location 23 for each product 17 is selectable from the active product locations 23a. The product data 17a may further include a price, a textual description, images, stock, categories (including, if appropriate sub-category, and sub-sub-category), identifications (e.g., SKUs), etc. The seller data 15a may include, for example, a seller name, an address, active and inactive inventory locations, billing information, etc. The e-commerce server system 12 is further configured to store the seller data 15a in a seller database 38 and to store the product data 17a in a product database 40.

The e-commerce server system 12 includes an e-commerce marketplace server program 18 executed on the server and configured to display a customer interface 20 of a customer computing device 14 that displays products viewed by a customer 13. A virtual shopping cart 19 of the e-commerce marketplace server program 18 is configured to have products 17 added to it by the customer 13, the virtual shopping cart 19 including an associated purchasing tool 21 for purchasing products 17 in the virtual shopping cart 19.

Specifically, the customer interface 20 is configured to allow a customer 13 to search for a product 17 that a seller 15 has made available via the e-commerce server system 12, add the product 17 to a virtual shopping cart 19, and purchase the product 17 via a purchasing tool 21 of the e-commerce marketplace server program 18, via a customer computing device 14. The customer interface 20 is further configured to acquire historical cart data 28 about customer interactions with the customer interface 20. The e-commerce marketplace server system 12 is configured to store the customer data in a customer database 37.

The e-commerce server system 12 also includes a data collection module 26 executed on the server and configured to monitor the various activities of all customer computing devices 14 that interact with the e-commerce marketplace server program 18 via the customer interface 20 and collect historical cart data 28 indicating customer views of products 17, products added to virtual shopping carts 19, and products purchased via the purchasing tool 21. The data collection module 26 may be further configured to store historical cart data 28 in data store 29 stored in non-volatile memory associated with the e-commerce server system 12. Historical cart data 28 may include data indicating, for each product available at the e-commerce server system 12, all virtual shopping cart instances created by customers 13 who added such products 17 to a virtual shopping cart 19 via customer interface 20 when shopping. Further, the virtual shopping cart instances include data indicating whether or not the product 17 was ultimately purchased, the geographical location of the customer 13 who created the virtual shopping cart 19, the shipping distance, shipping cost, and shipping time, as well as the percentage of shipping cost to entire purchase cost. Although not depicted in FIG. 1, it will be appreciated that data collection module 26 may also store historical views data indicating the number of times customers have viewed each of the products 17 via customer interface 20 to the e-commerce marketplace server program 18.

The e-commerce server system 12 further includes a logistic regression conversion module 30 is configured to examine the historical cart data 28 configured to compute a conversion rate 32 for the target product 17 based on the historical shopping cart data 28, the conversion rates 32 being also stored in data store 29. Typically, products on the e-commerce server system 12 are organized into categories, sub-categories, and sub-sub-categories, and the logistic regression conversion module 30 is run for historical cart data 28 for each sub-sub-category. Further, the logistic regression conversion module 30 typically takes various parameters contained in the historical cart data 28 that are related to shipping as input factors, such as a freight cost, a shipping time, a percentage of total purchase cost represented by the freight cost, a shipping distance, etc. Each conversion rate 32 is calculated using the following equation (1):

Pr(Cart to Order Conversion Rate)=Maxⱼ[Pr(Pᵢ,ToZipᵢ,PLocationⱼ)] (1)

Where Pᵢ is the product for the i^{th} virtual shopping cart, ToZipᵢ is a delivery location, PLocationⱼ is the location of the j^{th} active product location, Pr(Pᵢ, ToZipᵢ, PLocationⱼ)] is the probability that the i^{th} virtual shopping cart will convert to a purchase if sourced from the j^{th} active product location.

Historical cart data 28 may include product view, product selection, freight request, and product purchase. For example, a customer 13 may search for a product 17 via the customer interface 20 (i.e. product search), view the product details and product price associated with the products 17 (i.e. product view), add one or more products to a virtual shopping cart 19 (i.e. product selection), determine the shipping cost and shipping time for the one or more products added to the virtual shopping cart 19 (i.e. freight request), and finally choose to purchase one or more products 17 originally added to the virtual shopping cart 19 via the purchasing tool 21 (i.e. product conversion).

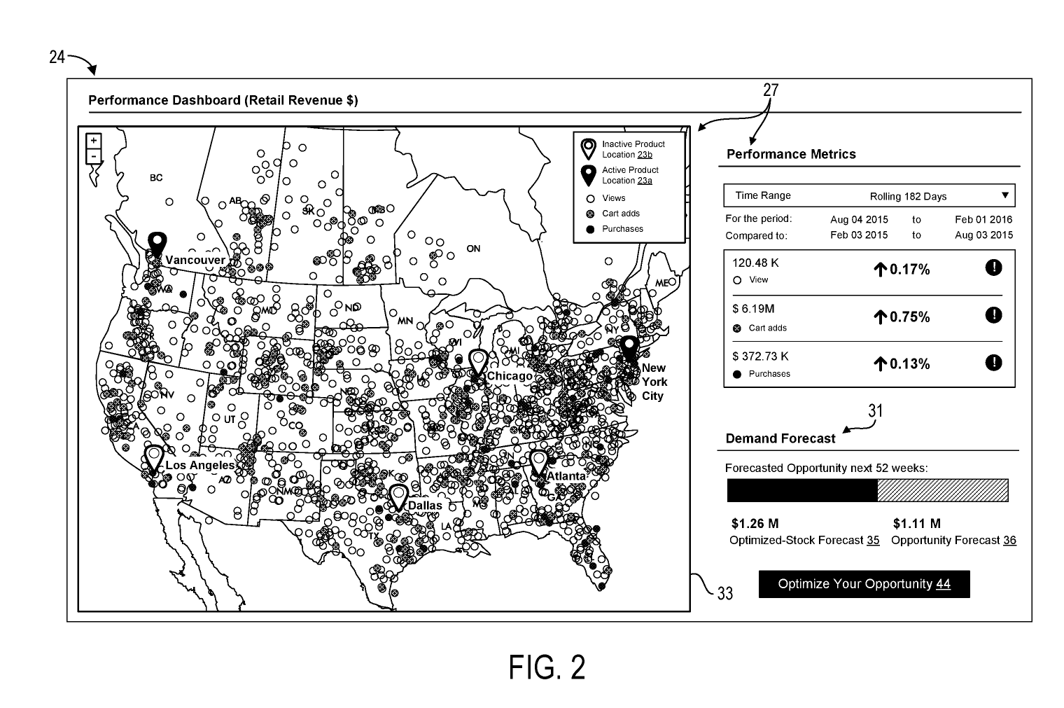

As shown in FIG. 2, the seller interface 24 is further configured to display a performance metrics tool 27 to the seller 15. The performance metrics tool 27 may show the seller 15 the historical cart data 28 associated with a target product 17. This historical cart data 28 is plotted on a product map 33 to present a geographical distribution of demand for the target product 17, and may show one or more types of historical cart data 28 associated with the target product 17, e.g. product views (views), product selections (cart adds), and product conversions (purchases). As shown on in the top right of FIG. 2, the performance metrics tool 27 may also allow the seller 15 to compare performance metrics 27a for different historical time ranges. This historical cart data 28 is generated via all prior interactions by all customers 13 of the e-commerce marketplace server program 18 with the target product 17. The product map 33 of the performance metrics tool 27 further shows the locations of the plurality of product locations 23 where the inventory for the seller's products can be stored. Each product location 23 is designated either as an active product location 23a if the seller 15 currently stores inventory in the product location 23, or as an inactive product location 23b if the seller 15 does not currently store inventory in the product location 23. In some examples, by adding product 17 to an inactive product location 23b, the inactive product location 23b may be automatically converted to an active product location 23a.

The historical cart data 28 presented in the performance metrics tool 27 may then be used to calculate a product conversion rate 32 via the logistic regression conversion modules 30, as described above. The product conversion rate 32 represents the likelihood that a target product 17 will be purchased after it is added to a virtual shopping cart 19 (i.e. converted into a purchase from a selection). The product conversion rate 32 can either be an actual product conversion rate 32a calculated only from collected data, or a potential product conversion rate 32b calculated from historical cart data 28 and hypothetical product stock and product distribution plan 39, which are both calculated by the logistic regression conversion module 30. The actual product conversion rate 32a is determined by examining historical cart data 28 for the number of times that a customer 13 adding a target product 17 to a virtual shopping cart 19 and the number of times that the customer 13 went on to purchase that target product 17 after adding the target product to the virtual shopping cart 19. This actual product conversion rate 32a can be determined independently for conversions associated with each of the active product locations 23a to generate location-specific actual product conversion rates 32a.

The seller interface server program 22 further includes a demand forecasting tool 31 configured to compute demand forecasts including a base demand forecast 34, an optimized-stock demand forecast 35, and an opportunity demand forecast 36. The demand forecasts may be determined using at least the historical cart data 28, the product conversion rates 32, the configuration of the plurality of product locations 23, and the product stock levels input by the seller 15. Furthermore, each type of demand forecast may be calculated based on a different subset of product locations 23. Each demand forecast may be calculated using the following equation (2):

$$Ex ( Sales ) = {\sum }_{all carts} Pr ( Cart to Order Conversion Rate ) . Cart Value \$ \qquad ( 2 )$$

Where Pr (Cart to Order Conversion Rate) is calculated using equation (1) with a variable subset of product locations depending on the type of demand forecast (see below), and CartValue$ is the average virtual shopping cart value for a target product.

A base demand forecast 34 represents the predicted total sales volume 41 over a predetermined time period if the actual product conversion rate 32a and the current distribution of active product locations 23a for the target product 17 continue, and the base demand forecast 34 is computed for a predetermined time period based on actual shopping cart conversions over a corresponding past period of time determined from the historical cart data. The base demand forecast 34 assumes that the raw in-stock percentage (as measured over a prior period of time, such as 52 weeks) will remain the same going forward, as will the raw demand distribution, i.e. the product conversion rates 32 for each virtual shopping cart 19 and ship-to location. The base demand forecast 34 may account for seasonal variation in demand by applying a seasonality function to the raw demand distribution, which adjusts the raw demand distribution upwards or downwards based on historical seasonal trends, for example over a 1-year period.

An optimized-stock demand forecast 35 represents the true demand for a product 17 before an out-of-stock condition causes freight considerations to (e.g. a freight cost, a shipping time, a percentage of total purchase cost represented by the freight cost, a shipping distance, etc.) influence the customer's decision to purchase a product 17. The optimized-stock demand forecast 35 is computed by examining the historical cart data 28 and determining a set of the virtual shopping carts 19 within the corresponding past period of time in which the target product 17 was not purchased and was out of stock, or in which the target product 17 was out of stock in a product location 23 with a highest conversion rate 32 and was purchased from a product location 23 with a lower than highest conversion rate 32. For each of the virtual shopping carts 19 in the set identify a highest potential conversion rate 32b among the active product locations 23a, and augment the base demand forecast 34 by the highest potential conversion rate 32b for each of the virtual shopping carts 19.

Specifically, to calculate the optimized-stock demand forecast 35, an optimized-stock conversion module 30 is used to predict the potential conversion rates 32 that could be expected for the target product 17 in alternative product distribution plans 39. The optimized-stock conversion module 30 is implemented as a logistic regression model that is a function of the plurality of freight considerations (variables) associated with the active product locations 23a. This has the advantage of removing the effect of freight considerations on the estimated demand. This has the advantage over an approach of attempting to calculate demand independent of freight considerations by offering free shipping or subsidized shipping, as these two approaches can undesirably bias the demand signal since they ultimately increase the cost of the underlying product in order to subsidize the shipping costs. Further, even if the cost of shipping is removed as a factor, the time to ship is not removed and therefore the effect of shipping on demand cannot completely be removed by subsidizing the shipping. An approach such as described herein removes the effect of freight considerations including freight cost, shipping time, percentage of total purchase cost represented by the freight cost, and shipping distance from the calculated demand distribution.

The optimized-stock demand forecast 35 is determined by adjusting the actual product purchases to reflect expected product purchases had the product been in-stock at the active product location 23a with the highest actual conversion rate 32a. Expected purchases are determined by looking at each of the virtual shopping carts 19 in a set and identifying all the active product locations 23a, e.g. active fulfillment warehouses, where stock should have been available for the product 17, and determining the potential conversion rate 32 of each of the virtual shopping carts 19 had a freight request indicated that it was being shipped from each of the active product locations 23a. The set includes the virtual shopping carts 19 to which a target product 17 had been added, but which did not result in a purchase of the target product 17 due to the target product 17 being out of stock, and the virtual shopping carts 19 in which the target product 17 was out of stock in an active product location 23a with a highest conversion rate 32 and was purchased from an active product location 23a with a lower than highest conversion rate 32. For each freight request for the target product in the historical cart data 28, the active product location 23a with the highest conversion rate 32 is identified and, if the target product 17 had not been in-stock at this product location 23 at the time the target product 17 was added to the virtual shopping cart 19 (product selection), the base demand forecast 34 is adjusted to reflect a hypothetical in-stock situation. Although, the optimized-stock demand forecast 35 may be preferentially expressed in terms of forecast revenue from sales of the target product 17 during a predetermined time period, any suitable forecast measurement may be used, such as a forecasted total sales volume. In this manner, the expected value of each of the virtual shopping carts 19 that contained the target product 17 can be recalculated under optimized in-stock conditions.

This optimized-stock demand forecast 35 reflects the base demand forecast 34 plus the demand that could have been fulfilled given the current distribution of active fulfillment warehouses in an idealized product distribution plan 39, and can be extrapolated over a predetermined time period to predict the total sales volume 41 of the target product 17. This process is repeated for the plurality of products 17 input into the e-commerce server system 12 by the seller 15. Based on the quantities of product stock for the plurality of products 17, the highest potential product conversion rates 32b for the plurality of products calculated by the optimized-stock conversion module 30, and the prices of the plurality of products 17, the optimized-stock demand forecast 35 determines the total revenue possible within the predetermined time period.

It will be appreciated that the active product locations 23a and the inactive product locations 23b may also be referred to as fulfillment warehouses. Furthermore, the active product locations 23a and the inactive product locations 23b may be fulfillment warehouses managed by an operator of the e-commerce server system 12, for example, or the active product locations 23a and the inactive product locations 23b may include some fulfillment warehouses managed by the operator of the e-commerce server system 12 and some fulfillment warehouses managed by the seller 15.

The demand forecasting tool 31 may then be further configured to compute an opportunity demand forecast 36 to determine the increase in revenue that could be expected if the product 17 had been held at a product location 23 having the highest conversion rate 32, even if that product location 23 is an inactive product location 23b. The opportunity demand forecast 36 may be computed by, for each of the virtual shopping carts 19 in the set, identifying a highest potential conversion rate 32b among the active product locations 23a and the inactive product locations 23b, and augmenting the base demand forecast 34 by the highest potential conversion rate 32b for each of the virtual shopping carts 19 in the set.

An example of the opportunity demand forecast 36 is shown alongside a corresponding base demand forecast 34 in FIG. 2 (bottom right). To generate the opportunity demand forecast 36, an opportunity conversion module 30 is used to predict the potential conversion rates 32b that could be expected for the target product 17 in alternative product distribution plans 39. As described above, the opportunity logistic regression conversion module 30 is implemented as a logistic regression model that is a function of a plurality of freight considerations (variables) associated with all possible product locations 23. The opportunity demand forecast 36 is calculated by adjusting the actual product conversions to reflect expected product conversions had the product been in-stock at any product location 23, including those currently designated as inactive product locations 23b. Specifically, for each freight request for the target product 17 in the historical cart data 28, a potential product conversion rate 32b is identified if the product 17 had been in-stock at each of the active product locations 23a and inactive product locations 23b at the time the target product 17 was added to the virtual shopping cart 19 (i.e. product selection). The highest potential product conversion rate 32b is found for the target product 17 if all possible product locations 23 were available, and this potential conversion rate 32b is then used to predict the total sales volume 41 over a predetermined time period. This process is repeated for the plurality of products 17 input into the e-commerce server system 12 by the seller 15. Based on the quantities of product stock for the plurality of products, the highest potential product conversion rates 32b for the plurality of products 17 calculated by the opportunity conversion module 30, and the prices of the plurality of products 17, the opportunity demand forecast 36 determines the total revenue possible for the seller 15 within the predetermined time period.

The difference between the optimized-stock demand forecast 35 and the opportunity demand forecast 36 represents the potential revenue opportunity that is not currently being accessed by the seller 15 due to product locations 23 being designated as inactive product locations 23b. An example of this configuration is shown in FIG. 2, where a demand forecasting tool 31 is displayed to the seller 15, via the seller interface 24, and shows the potential revenue based on the optimized-stock demand forecast 35 (Optimized-Stock Forecast) and the potential revenue based on the opportunity demand forecast 36 (Opportunity Forecast) for the next fifty-two weeks.

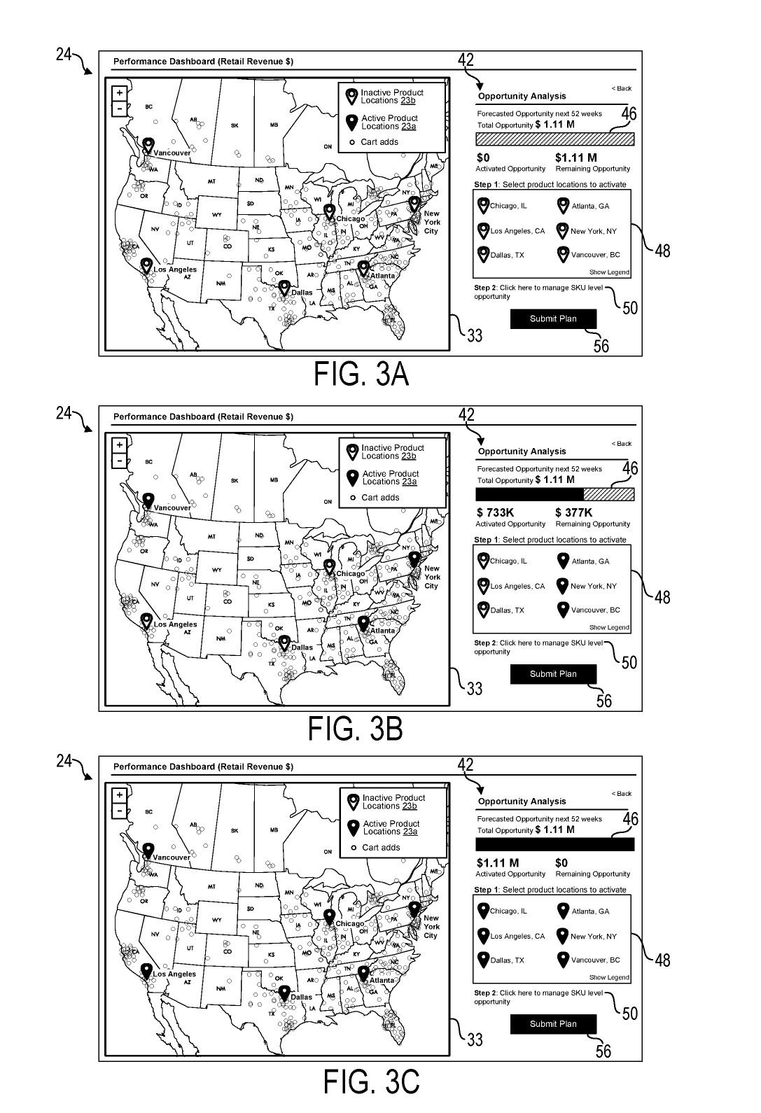

The seller interface 24 of the seller interface server program 22 is configured to display or cause to be displayed at least a result of the optimized-stock demand forecast 35, and the seller interface 24 may be further configured to display or cause to be displayed the results of the base demand forecast 34 and the opportunity demand forecast 36. For example, the seller interface may present the seller 15 with an opportunity analysis tool 42. As shown in FIG. 2, this feature can be accessed by selecting an optimization button 44 in the seller interface 24, which may say: “Optimize Your Opportunity,” or a related phrase. After selection of the optimization button 44, the opportunity analysis tool 42 may be displayed to the seller 15, as shown in FIG. 3A.

The opportunity analysis tool 42 of the demand forecasting tool 31 is further configured to enable the seller 15 to modify the active product locations 23a to simulate a modified set of active product locations 23a, and re-compute the optimized-stock demand forecast 35 based on the modified set of active product locations 23a. This allows the seller to evaluate changes in the potential revenue opportunity upon activation of one or more of the plurality of product locations 23, enabling the seller 15 to determine the impact of activating new product locations 23 on the seller's 15 total revenue. Specifically, as shown in FIG. 3A, the opportunity analysis tool 42 may display the potential revenue opportunity to the seller 15 as, for example, a total opportunity bar 46. Although, the opportunity demand forecast 36 may be preferentially expressed in terms of forecast revenue from sales of the target product 17 during the predetermined time period, any suitable forecast measurement may be used, such as forecasted total sales volume. The product locations 23 may indicate several variables, including whether the product location is an active product location 23a or an inactive product location 23b, whether the product location is owned by the seller 15 or owned by the e-commerce system 10 (as discussed above in relation to inactive and active fulfillment warehouses), or any other suitable information about the product location 23. These product location variables may be encoded via color, marker shape, label, or the like. Furthermore, the historical cart data 28 may also be displayed on the product map 33 as a quick reference for the geographical distribution of demand, as shown for product views (i.e. cart adds) in FIGS. 3A-3C.

As shown in FIG. 3B, an interactive version of the product map 33 and an interactive location list 48 may further allow the seller 15 to quickly set product locations 23 as either an active product location 23a or an inactive product location 23b. Selection of an inactive product location 23b (via the interactive product map 33 or the interactive location list 48) will display the change in potential revenue opportunity in the total opportunity bar 46, where the activated potential revenue for the seller 15 is referred to in this example as an “activated opportunity” and the remaining potential revenue opportunity is referred to as a “remaining opportunity”. The seller 15 may select to activate any combination of product locations 23 to determine a product distribution plan 39 to optimize the needs of the seller 15 and balance increased total revenue with possible costs associated with shipping products to new product locations. As shown in FIG. 3C, if the maximum total revenue for the seller 15 is attained, the total opportunity bar 46 will indicate that the activated opportunity is equal to the potential revenue opportunity shown in FIG. 3A, and that the remaining opportunity is indicated as zero.

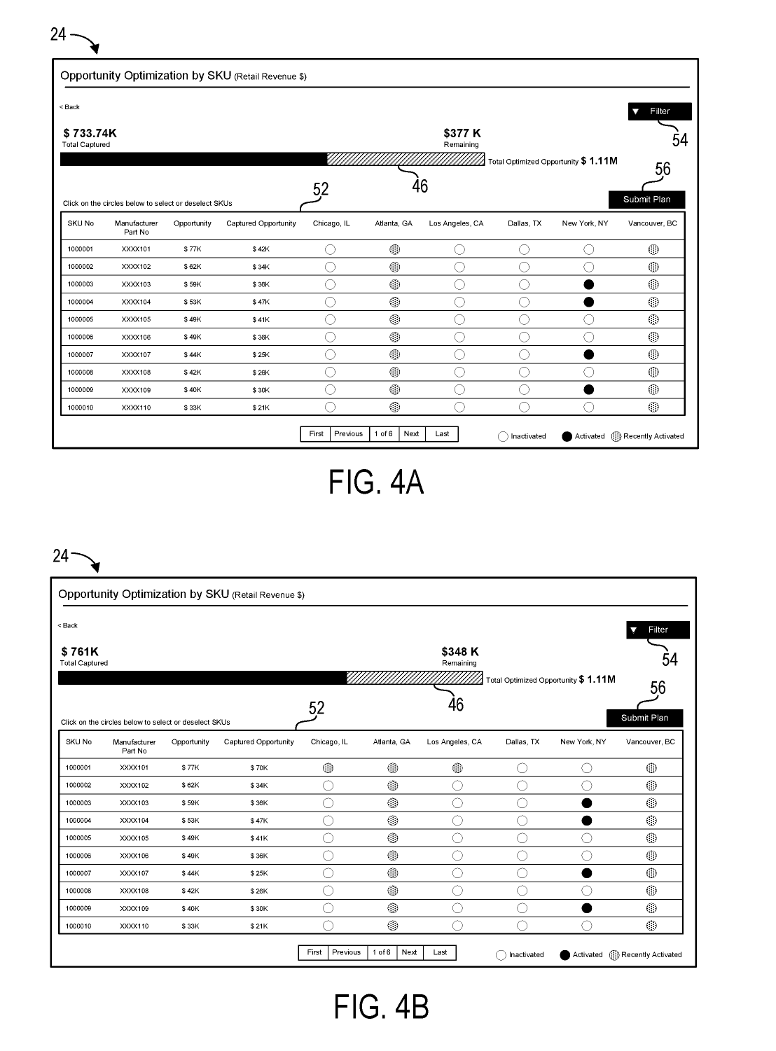

Evaluation of the effects of alternate product locations on potential revenue opportunity can be performed for all products en masse or for a single target product 17 individually. This level of control allows the seller 15 to activate only a subset of their products 17 at each product location 23 based on the seller's 15 constraints. As shown in FIGS. 3A-C, a second step of the opportunity analysis tool 42 allows the seller 15 to optimize the potential revenue opportunity by an individual product identifier associated with each product 17, i.e. a product SKU. In the example illustrated in FIGS. 3A-C, the seller 15 may select a SKU optimization link 50 for the second step, labeled in this example as: “Click here to manage SKU level opportunity.” Upon selection of the SKU optimization link 50 the seller 15 is taken to a new interface, as shown in FIG. 4A, showing the total opportunity bar 46 from the main opportunity analysis tool 42 interface, but the seller 15 may now select to locate each of the plurality of products 17 in each of the plurality of product locations 23 by activating product locations 23 for only a subset of product SKUs (see FIG. 4B) within a product location list 52. Giving the seller 15 the ability to fine-tune their product distribution plan 39 to optimize the total product revenue based on individual products 17. Furthermore, the opportunity analysis tool 42 may be further configured to automatically determine the product distribution plan 39 based on a predetermined set of product distribution parameters, and the seller 15 may refine the product distribution plan 39 by selecting filters via a filer button 54, labeled here as: “Filter.”

Once the seller 15 has completed the product distribution plan 39, they may select to submit their product distribution plan 39 to the e-commerce server system 12. In the example illustrated in FIG. 4A-B, this is achieved by selecting the submit button 56, labeled here as: “Submit Plan.” The product distribution plan 39 is communicated back to the e-commerce server system 12, where the product location data is updated in the product database 40 and the product demand forecasts are recalculated.

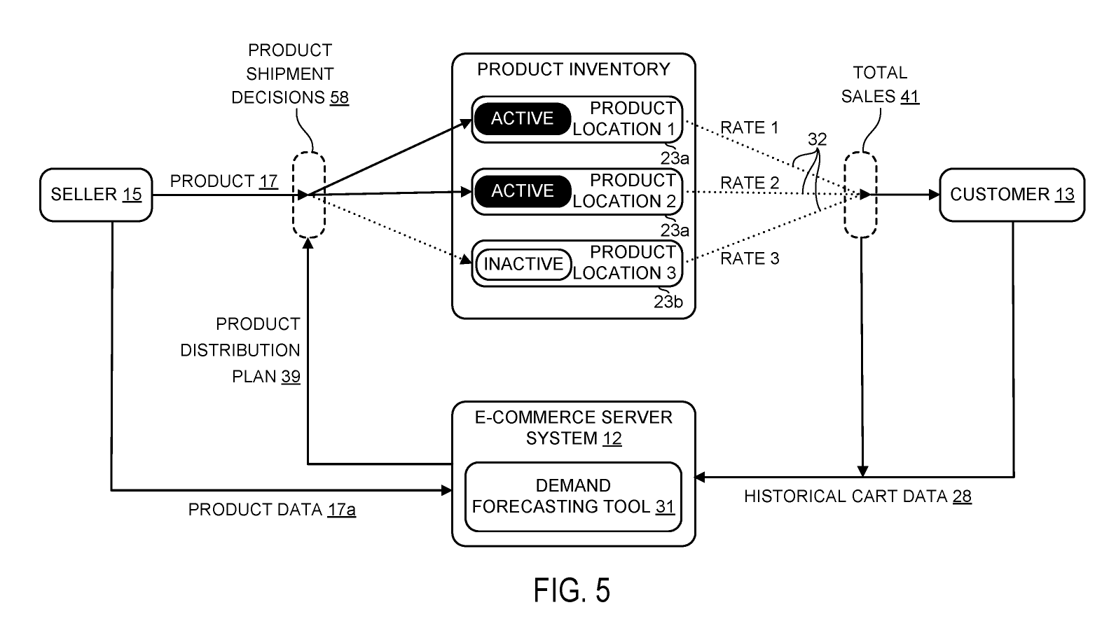

Turning now to FIG. 5, the product distribution plan 39 is used by the seller 15 and the e-commerce server system 12 to determine product shipment decisions 58, including the quantity of each of the plurality of products 17 to distribute to each of the plurality of active product locations 23a at predetermined intervals. The shipment of products 17 to the active production locations 23a may be performed directly by the seller 15, through a third-party shipping company, or by a shipping system of the e-commerce system 10. The example shown in FIG. 5 illustrates two active product locations 23a and one inactive product location 23b, however, it will be obvious that any number of product locations 23 or any combination of active product locations 23a and inactive product locations 23b can be imagined. Furthermore, changes to the product distribution plan 39 may change the designation of each product location 23 from either an active product location 23a to an inactive product location 23b, or vice versa. The demand forecasting tool 31 constantly updates the demand forecasts with new conversion rates 32 for each product location 23, calculated by the e-commerce server system 12 as described previously, from new user interactions with the e-commerce marketplace server program 18, updated historical cart data 28, and new product data supplied by the seller 15.

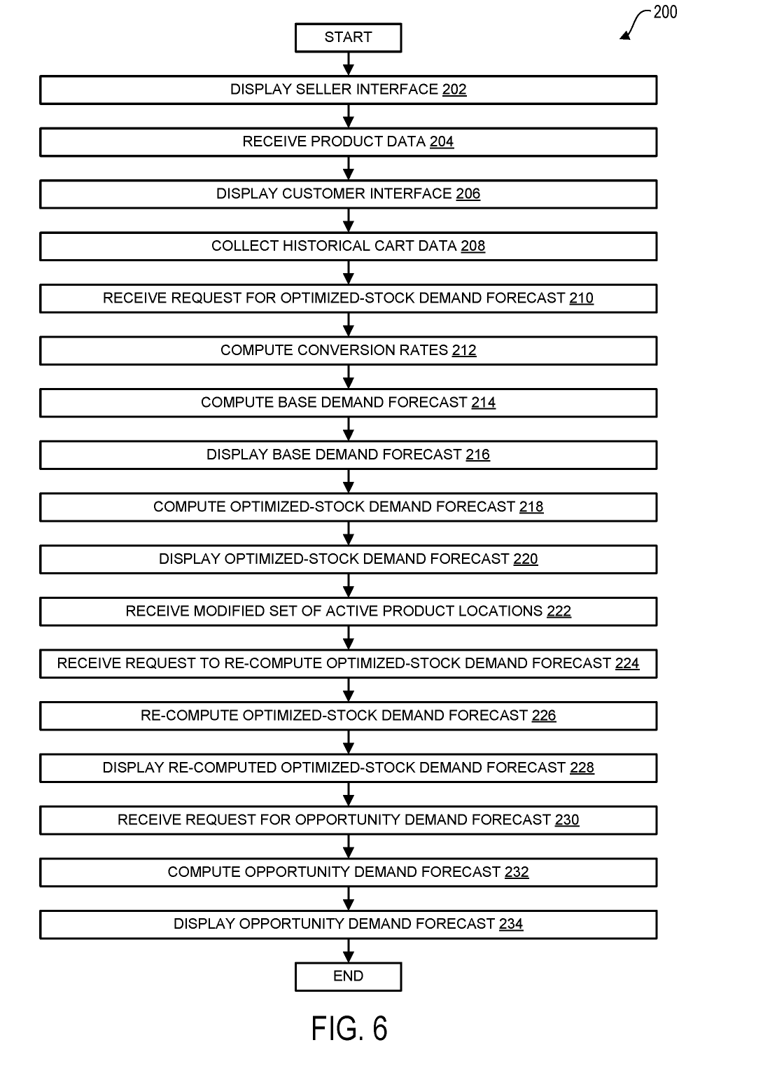

FIG. 6 shows a flow diagram depicting an example method 200 for creating demand forecasts for an e-commerce system 10. The following description of method 200 is provided with reference to the software and hardware components described above and shown in FIGS. 1-5. It will be appreciated that method 200 also may be performed in other contexts using other suitable hardware and software components.

At 202, the method may include displaying or causing to be displayed a seller interface 24 of a seller computing device by which the seller 15 may upload product data 17a on one or more products 17 to be offered for sale. In response, at 204, the method may include receiving product data 17a via an uploading tool 25. The product data 17a may include a product identification, a product price, and a product location 23 for each product. At 206, the method may further include displaying or causing to be displayed a customer interface 20 that displays products 17 viewed by a customer 13, and provides a virtual shopping cart 19 configured to have the products 17 added to it by the customer 13, the virtual shopping cart 19 including an option to purchase the products 17 in the virtual shopping cart 19. At 208, the method may include collecting historical cart data 28 indicating customer views of products 17, products added to virtual shopping carts 19, and products purchased at an e-commerce server system 12 through the customer interface 20.

At 210, the method may further include receiving a request for an optimized-stock demand forecast 35 for a target product 17 from a seller 15 of the target product 17. The seller 15 may maintain a plurality of product locations 23 that store and ship the target product 17, and the product locations 23 may be active product locations 23a or inactive product locations 23b depending on a designation by the seller 15. The product location 23 included in the product data 17a for each product 17 is preferentially selected from active product locations 23a. Furthermore, the active product locations 23a and the inactive product locations 23b may be fulfillment warehouses managed by an operator of the e-commerce server system 12 and/or fulfillment warehouses managed by the seller 15.

At 212, the method may then include computing a conversion rate 32 for the target product 17 based on the historical shopping cart data 28. As shown at 214, the method may then include computing a base demand forecast 34 for a predetermined time period based on actual shopping cart conversions for the target product 17 over a corresponding past period of time determined from historical cart data 28. At 216, after computing the base demand forecast 34, the method may further include displaying or causing to be displayed the base demand forecast 34 by, for example, a seller interface 24 of a seller computing device 16.

Continuing with method 200, at 218, the method may include computing the optimized-stock demand forecast 35 by examining the historical cart data 28 and determining a set of the virtual shopping carts 19 within the past corresponding period of time in which the target product 17 was not purchased and was out of stock, or in which the target product 17 was out of stock in a product location 23 with a highest conversion rate 32 and was purchased from a product location 23 with a lower than highest conversion rate 32, and for each of the virtual shopping carts 19 in the set, identifying a highest potential conversion rate 32b among the active product locations 23a and augmenting the base demand forecast 34 by the highest potential conversion rate 23b for each of the virtual shopping carts 19. The optimized-stock demand forecast 35 may be expressed in terms of forecast revenue from sales of the target product 17 during a predetermined time period. At 220, the method may then include displaying or causing to be displayed at least a result of the optimized-stock demand forecast 35, by, for example, a seller interface 24 of a seller computing device 16.

In some examples, the method may further include, at 222, receiving a modified set of active product locations 23a, and, at 224, a request to re-compute the optimized-stock demand forecast 35 from the seller 15. In response, at 226, the method may cause the e-commerce server system 12 to re-compute the optimized-stock demand forecast 35 based on the modified set of active product locations 23a, and display or cause to be displayed at least a re-computed result of the optimized-stock demand forecast 35, at 228.

In another non-limiting example, the method may further include, at 230, receiving a request for an opportunity demand forecast 36 for the target product 17 from the seller 15 of the target product 17. In response, at 232, the method may then include computing the opportunity demand forecast 36 by, for each of the virtual shopping carts 19 in the set, identifying a highest potential conversion rate 32b among the active product locations 23a and inactive product locations 23b, and augmenting the base demand forecast 34 by the highest potential conversion rate 32b for each of the virtual shopping carts 19. Although, the opportunity demand forecast 36 may be preferentially expressed in terms of forecast revenue from sales of the target product 17 during the predetermined time period, any suitable forecast measurement may be used. Finally, at 234, the method may include displaying or causing to be displayed at least a result of the optimized-stock demand forecast 35 and the opportunity demand forecast 36.

It will further be appreciated that method 200 is provided by way of example and is not meant to be limiting. Therefore, it is to be understood that method 200 may include additional and/or alternative steps relative to those illustrated in FIG. 6, and all or some steps of method 200 may be repeated for identifying any additional demand forecasts. Further, it is to be understood that method 200 may be performed in any suitable order. Further still, it is to be understood that one or more steps may be omitted from method 200 without departing from the scope of this disclosure. In some embodiments, the methods and processes described herein may be tied to a computing system of one or more computing devices. In particular, such methods and processes may be implemented as a computer-application program or service, an application-programming interface (API), a library, and/or other computer-program product.

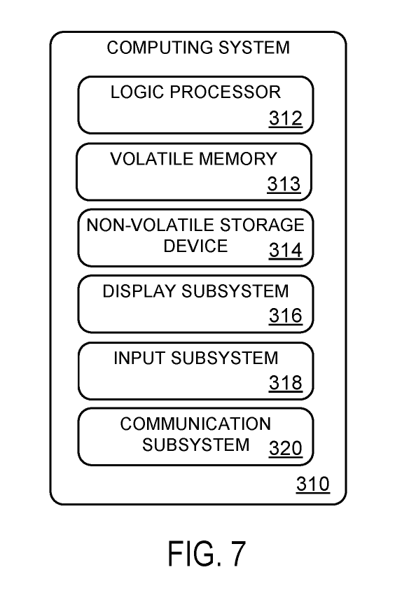

FIG. 7 schematically shows a non-limiting embodiment of a computing system 310 that can enact one or more of the methods and processes described above. Computing system 310 is shown in simplified form. Computing system 310 may embody a server of e-commerce server system 12 (of which it will be appreciated there may be several coordinated servers), customer computing device 14, and/or seller computing device 16 of FIG. 1. Computing system 310 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 310 includes a logic processor 312, volatile memory 313, and a non-volatile storage device 314. Computing system 310 may optionally include a display subsystem 316, input subsystem 318, communication subsystem 320, and/or other components not shown in FIG. 7.

Logic processor 312 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 312 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 312 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 314 includes one or more physical devices configured to hold instructions executable by the logic processors to implement the methods and processes described herein. When such methods and processes are implemented, the state of non-volatile storage device 314 may be transformed—e.g., to hold different data.

Non-volatile storage device 314 may include physical devices that are removable and/or built-in. Non-volatile storage device 314 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 314 may include nonvolatile, dynamic, static, read/write, read-only, sequential-access, location-addressable, file-addressable, and/or content-addressable devices. It will be appreciated that non-volatile storage device 314 is configured to hold instructions even when power is cut to the non-volatile storage device 314.

Volatile memory 313 may include physical devices that include random access memory. Volatile memory 313 is typically utilized by logic processor 312 to temporarily store information during processing of software instructions. It will be appreciated that volatile memory 313 typically does not continue to store instructions when power is cut to the volatile memory 313.

Aspects of logic processor 312, volatile memory 313, and non-volatile storage device 314 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 310 typically implemented in software by a processor to perform a particular function using portions of volatile memory, which function involves transformative processing that specially configures the processor to perform the function. Thus, a module, program, or engine may be instantiated via logic processor 312 executing instructions held by non-volatile storage device 314, using portions of volatile memory 313. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 316 may be used to present a visual representation of data held by non-volatile storage device 314. The visual representation may take the form of a graphical user interface (GUI). As the herein described methods and processes change the data held by the non-volatile storage device, and thus transform the state of the non-volatile storage device, the state of display subsystem 316 may likewise be transformed to visually represent changes in the underlying data. Display subsystem 316 may include one or more display devices utilizing virtually any type of technology. Such display devices may be combined with logic processor 312, volatile memory 313, and/or non-volatile storage device 314 in a shared enclosure, or such display devices may be peripheral display devices.

When included, input subsystem 318 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 320 may be configured to communicatively couple various computing devices described herein with each other, and with other devices. Communication subsystem 320 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 310 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An e-commerce server system, comprising:
a seller interface server program executed on a server of the e-commerce server system configured to display a seller interface by which a seller may upload product data on one or more products to be offered for sale, and by which the seller may designate a plurality of product locations that can store and ship products, the plurality of product locations being active product locations or inactive product locations depending on a designation by the seller, wherein the product data includes a product identification, a product price, and a product location for each product, and wherein the product location for each product is selectable from the active product locations;
an e-commerce marketplace server program executed on the server and configured to display a customer interface that displays products viewed by a customer, and provides a virtual shopping cart configured to have products added to it by the customer, the virtual shopping cart including an associated purchasing tool for purchasing products in the virtual shopping cart;
a data collection module executed on the server configured to collect historical cart data indicating customer views of products, products added to virtual shopping carts, and products purchased via the purchasing tool; and
a logistic regression conversion module configured to compute a conversion rate for the target product based on the historical shopping cart data;
wherein the seller interface server program includes a demand forecasting tool configured to:
compute a base demand forecast for a predetermined time period based on actual shopping cart conversions over a corresponding past period of time determined from the historical cart data;
compute an optimized-stock demand forecast by examining the historical cart data and determining a set of the virtual shopping carts within the corresponding past period of time in which the target product was not purchased and was out of stock, or in which the target product was out of stock in a product location with a highest conversion rate and was purchased from a product location with a lower than highest conversion rate, and for each of the virtual shopping carts in the set identify a highest potential conversion rate among the active product locations, and augment the base demand forecast by the highest potential conversion rate for each of the virtual shopping carts; and
display or cause to be displayed at least a result of the optimized-stock demand forecast.

2. The e-commerce server system of claim 1,
wherein the demand forecasting tool is further configured to enable the seller to modify the active product locations to simulate a modified set of active product locations, and re-compute the optimized-stock demand forecast based on the modified set of active product locations.

3. The e-commerce server system of claim 1,
wherein the demand forecasting tool is further configured to:
compute an opportunity demand forecast by, for each of the virtual shopping carts in the set, identifying a highest potential conversion rate among the active product locations and the inactive product locations, and augmenting the base demand forecast by the highest potential conversion rate for each of the virtual shopping carts in the set; and
display or cause to be displayed at least a result of the opportunity demand forecast.

4. The e-commerce server system of claim 3, wherein the active product locations and the inactive product locations are fulfillment warehouses.

5. The e-commerce server system of claim 4, wherein the active product locations and the inactive product locations are fulfillment warehouses managed by the operator of the e-commerce server system.

6. The e-commerce server system of claim 4, wherein the active product locations and the inactive product locations include fulfillment warehouses managed by the operator of the e-commerce server system and fulfillment warehouses managed by the seller.

7. The e-commerce server system of claim 3, wherein the opportunity demand forecast is expressed in terms of forecast revenue from sales of the target product during the predetermined time period.

8. The e-commerce server system of claim 1, wherein optimized-stock demand forecast is expressed in terms of forecast revenue from sales of the target product during the predetermined time period.

9. A method, comprising:
collecting historical cart data indicating customer views of products, products added to virtual shopping carts, and products purchased at an e-commerce server system;
receiving a request for an optimized-stock demand forecast for a target product from a seller of the target product, the seller maintaining a plurality of product locations that store and ship the target product, and the product locations being active product locations or inactive product locations depending on a designation by the seller;
computing a conversion rate for the target product based on the historical shopping cart data;
computing a base demand forecast for a predetermined time period based on actual shopping cart conversions for the target product over a corresponding past period of time determined from historical cart data;
computing the optimized-stock demand forecast by examining the historical cart data and determining a set of the virtual shopping carts within the past corresponding period of time in which the target product was not purchased and was out of stock, or in which the target product was out of stock in a product location with a highest conversion rate and was purchased from a product location with a lower than highest conversion rate, and for each of the virtual shopping carts in the set, identifying a highest potential conversion rate among the active product locations and augmenting the base demand forecast by the highest potential conversion rate for each of the virtual shopping carts; and
displaying or causing to be displayed at least a result of the optimized-stock demand forecast.

10. The method of claim 9, further comprising:
displaying or causing to be displayed a seller interface by which the seller may upload product data on one or more products to be offered for sale.

11. The method of claim 10,
wherein the product data includes a product identification, a product price, and a product location for each product, and wherein the product location for each product is selected from the active product locations.

12. The method of claim 9, further comprising:
displaying or causing to be displayed a customer interface that displays products viewed by a customer, and provides a virtual shopping cart configured to have the products added to it by the customer, the virtual shopping cart including an option to purchase the products in the virtual shopping cart.

13. The method of claim 9, further comprising:
receiving a modified set of active product locations and a request to re-compute the optimized-stock demand forecast from the seller;
re-computing the optimized-stock demand forecast based on the modified set of active product locations; and
displaying or causing to be displayed at least a re-computed result of the optimized-stock demand forecast.

14. The method of claim 9, further comprising:
receiving a request for an opportunity demand forecast for the target product from the seller of the target product;
computing the opportunity demand forecast by, for each of the virtual shopping carts in the set, identifying a highest potential conversion rate among the active product locations and inactive product locations, and augmenting the base demand forecast by the highest potential conversion rate for each of the virtual shopping carts; and
displaying or causing to be displayed at least a result of the optimized-stock demand forecast and the opportunity demand forecast.

15. The method of claim 9, wherein the active product locations and the inactive product locations are fulfillment warehouses.

16. The method of claim 15, wherein the active product locations and the inactive product locations are fulfillment warehouses managed by the operator of the e-commerce server system.

17. The method of claim 15, wherein the active product locations and the inactive product locations include fulfillment warehouses managed by the operator of the e-commerce server system and fulfillment warehouses managed by the seller.

18. The method of claim 14, wherein the opportunity demand forecast is expressed in terms of forecast revenue from sales of the target product during the predetermined time period.

19. The method of claim 9, wherein optimized-stock demand forecast is expressed in terms of forecast revenue from sales of the target product during the predetermined time period.

20. An e-commerce server system, comprising:
a seller interface server program executed on a server of the e-commerce server system configured to display a seller interface by which a seller may upload product data on one or more products to be offered for sale, and by which a seller may designate a plurality of product locations that can store and ship products, the plurality of product locations being active product locations or inactive product locations depending on a designation by the seller, wherein the product data includes a product identification, a product price, and a product location for each product, and wherein the product location for each product is selectable from the active product locations;
an e-commerce marketplace server program executed on the server and configured to display a customer interface that displays products viewed by a customer, and provides a virtual shopping cart configured to have products added to it by the customer, the virtual shopping cart including an associated purchasing tool for purchasing products in the virtual shopping cart;
a data collection module executed on the server computer configured to collect historical cart data indicating customer views of products, products added to virtual shopping carts, and products purchased via the purchasing tool; and
a logistic regression conversion module configured to compute a conversion rate for the target product based on the historical shopping cart data;
wherein the seller interface server program includes a demand forecasting tool configured to:
(1) compute a base demand forecast for a predetermined time period based on actual shopping cart conversions over a corresponding past period of time determined from the historical cart data;
(2) compute an optimized-stock demand forecast by examining the historical cart data and determining a set of the virtual shopping carts within the past corresponding period of time in which the target product was not purchased and was out of stock, or in which the target product was out of stock in a product location with a highest conversion rate and was purchased from a product location with a lower than highest conversion rate, and for each of the virtual shopping carts in the set identify a highest potential conversion rate among the active product locations, and augment the base demand forecast by the highest potential conversion rate for each of the virtual shopping carts in the set;
(3) compute an opportunity demand forecast by, for each of the virtual shopping carts, identifying a highest potential conversion rate among the active product locations and inactive product locations, and augmenting the base demand forecast by the highest potential conversion rate for each of the virtual shopping carts in the set; and
(4) display or cause to be displayed at least a result of the optimized-stock demand forecast and the opportunity demand forecast.
